(19) United States
(12) Patent Application Publication
(10) Pub. No.: US 2006/0109284 A1
(43) Pub. Date: May 25, 2006

(54) Method for image blending

(76) Inventors: Ming Jane Hsieh, Taipei City (TW); Cheng Shun Liao, Puyan Township (TW)

Correspondence Address: Raymond Sun, 12420 Woodhall Way, Tustin, CA, 92782, US

(21) Appl. No.: 11/286,112

(22) Filed: Nov. 23, 2005

(30) Foreign Application Priority Data
Nov. 25, 2004 (TW) 093136290

(51) Int. Cl. G09G 5/00

(52) U.S. Cl. 345/639

(57) ABSTRACT

A method for blending multiple layers of images into a blended image is disclosed. Each layer of image contains a plurality of pixels and has a corresponding transparent coefficient. At least one image-overlapping area is formed by overlapping at least two of the layers of images. The method employs a lookup table to store a plurality of weight coefficient sets, each of which corresponds to a subset of the layers of images and the transparent coefficients of the layers of images within the subset. Then, the method selects one of the weight coefficient sets in the lookup table according to the overlapped layers in the image-overlapping area, and blends a correspondingly located pixel of each overlapped layer to generate a blended pixel of the blended image according to values of the correspondingly located pixels and the selected weight coefficient set.

### BACKGROUND OF THE INVENTION

(a). Field of the Invention

The present invention relates to image processing, and more particularly, to a method for image blending.

(b). Description of the Prior Arts

Recently, it is increasingly universal to perform image processing in a digital manner, thanks to the rapid development of digital technology. In digital image processing, alpha blending (a blending) is a commonly used technique to display overlapping images on a display device (e.g. LCD display). If two layers of digital images X and Y are overlapped, the alpha blending executes the below computation for each location within the image-overlapping area:
p=αx+(1−α)y Eq. (1)

In Eq. (1), 0≦α≦1, while x and y represents the pixel values at the location for the images X and Y respectively. The pixel values may indicate the pixel luminosity or hue or both. The value p is the result of the alpha blending, and is used as the final pixel value at the location. It can be inferred from Eq. (1) that the relative proportions of the images X and Y for the image blending can be changed by adjusting the value of α.

Since the technology is rapidly developing and the demand for visual effects is increasingly higher, to display more than two overlapped layers of images is more and more pressing in practical application. Thus, what is needed is to extend the application of Eq. (1) such that the alpha blending for more than two layers of images can be performed effectively.

### SUMMARY OF THE INVENTION

It is therefore one of objectives of this invention to provide a method for performing an alpha blending for multiple layers of images. The method can change the proportion of each layer of image in the alpha blending by adjusting a corresponding alpha value of each layer of image, thereby achieving the desired visual effect.

Another objective of this invention is to provide a method for image blending which can employ a built-in lookup table of a display device to store required information for blending, thereby accelerating the image processing.

According to one embodiment of this invention, a method for image blending is provided. The method blends pixels of a plurality of overlapping layers of images in an image-overlapping area to generate a blended pixel in the image-overlapping area. Each overlapping layer of image has a plurality of pixels and a corresponding transparent coefficient. The method comprises the steps of: providing a lookup table, wherein the lookup table outputs a corresponding weight coefficient for each overlapping layer, and the corresponding weight coefficient is determined according to the transparent coefficients of the overlapping layers; and blending the pixels of the overlapping layers of images in the image-overlapping area and thereby generating the blended pixel according to values of the pixels of the overlapping layers of images and the corresponding weight coefficients outputted by the lookup table.

### BRIEF DESCRIPTION OF THE DRAWINGS

FIG. 1 is a flow chart of a preferred embodiment of the method for image blending according to this invention.

FIG. 2 is a diagram showing how the corresponding pixels are blended in the embodiment of FIG. 1.

### DETAILED DESCRIPTION OF THE INVENTION

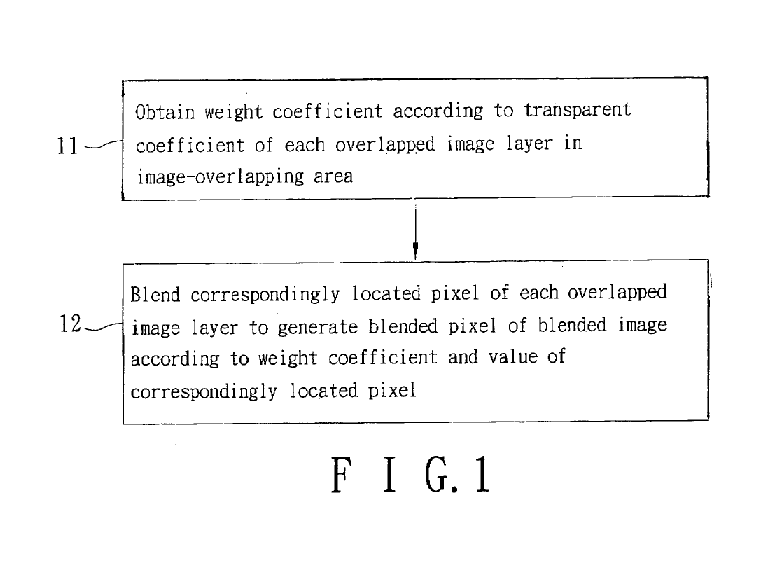

FIG. 1 is a flow chart of a preferred embodiment of the method for image blending according to this invention. In this embodiment, the method for image blending is applied to a display device, such as a LCD display. The display device has a plurality of image layers for placing the images provided from within or inputted from outside sources, and blends the image layers for display. The images from outside sources include video images (e.g. various file formats of films) and still images (e.g. various file formats of pictures), while the images provided from within include OSD (on-screen display) images, such as the control menu of the display device.

Each image has an alpha value for image blending. Since the alpha value represents the transparency of the image, it is also called transparent coefficient. When distributing a plurality of images onto the image layers to perform an image blending, the display device determines what the overlapped image layers are for an image-overlapping area, which is formed by overlapping two or more image layers. Then, the display device blends a correspondingly located pixel of each overlapped image layer to generate a blended pixel. As for an area without image overlapping, i.e. the area with only one layer of image, the display device just displays the only layer of image without blending. In this manner, a blended image is generated out of the distributed images. The flow in FIG. 1 includes the following steps:
Step 11: Obtaining a weight coefficient according to a transparent coefficient of each overlapped image layer in the image-overlapping area.
Step 12: Blending the correspondingly located pixel of each overlapped image layer to generate a blended pixel of the blended image according to the weight coefficient and the value of the correspondingly located pixel.

In step 11, each overlapped image layer is given a corresponding weight coefficient. The weight coefficient is equal to a ratio of the transparent coefficient of the corresponding overlapped image layer to the sum of the transparent coefficients of all the overlapped image layers. The value of the blended pixel is generated by multiplying the value of the correspondingly located pixel of each overlapped image layer with the corresponding weight coefficient and then adding them up. In step 12, the value of the blended pixel is equal to a weighted average.

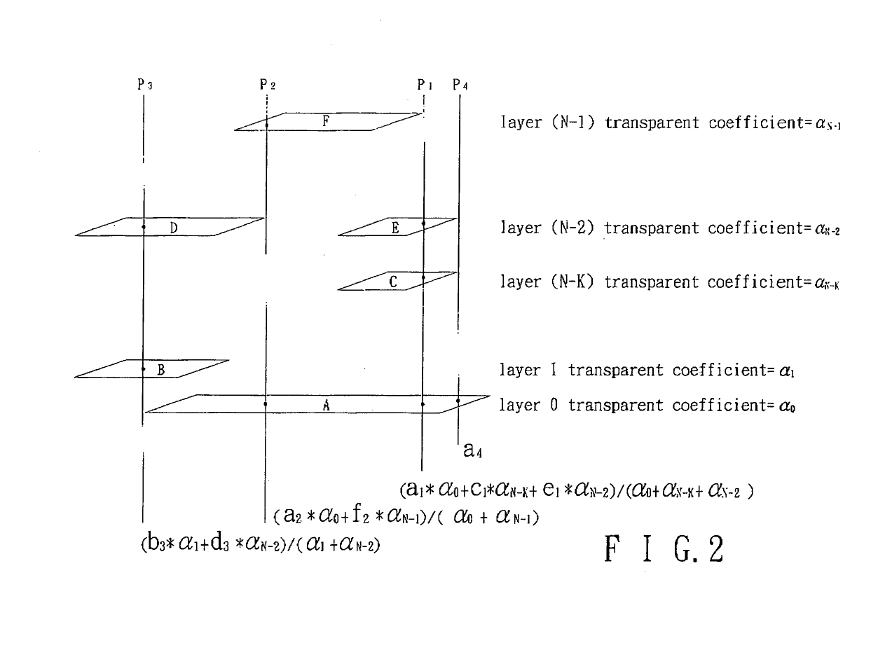

The display device executes steps 11 and 12 for each location within the image-overlapping area. Different image-overlapping areas may have different combinations of overlapped image layers, and thus the corresponding weight coefficient of the same overlapped image layer within different combinations may be different (see FIG. 2 below). In another embodiment, the transparent coefficient for each image layer of the display device is predetermined. Thus, a built-in lookup table can be used to store the weight coefficient, which can also be predetermined according to the predetermined transparent coefficients, of each overlapped image layer in each possible combination, and then the stored weight coefficients can be easily accessed for blending the corresponding pixels. In this manner, the speed of image blending can be accelerated, and the computational logic, especially dividers and adders, required for calculating the weighted average can also be saved to lower the hardware cost. In one embodiment, each predetermined weight coefficient is transformed into an approximate fraction with a denominator of 2ⁿ (n is a positive integer) before being stored into the lookup table. In this manner, when the corresponding pixels are blended, the division can be replaced by a much simpler bit-shifting operation. For example, if n is selected as 3 and the predetermined weight coefficients of two overlapped image layers are 0.4 and 0.6, then the predetermined weight coefficients can be transformed into the approximate fractions of ⅜(0.375) and ⅝(0.625) respectively.

FIG. 2 shows how the corresponding pixels are blended in the embodiment of FIG. 1. In FIG. 2, N image layers are shown and denoted as layer 0, layer 1 . . . layer (N-k) . . . layer (N-2) and layer (N-1), from bottom to top. The corresponding transparent coefficients (alpha value) are then α₀, α₁ . . . α_{N-2} and α_{N-1}, respectively. FIG. 2 shows six images A, B, C, D, E and F, where A is on layer 0, B is on layer 1, C is on layer (N-k), D and E are both on layer (N-2), and F is on layer (N-1). In FIG. 2, three locations (denoted as P₁, P₂, P₃) are selected as examples for explaining the blending operation of the corresponding image layers. The location P₁ lies in the image-overlapping area formed by overlapping the images A, C and E. That is, the overlapped image layers for this image-overlapping area are layer 0, layer (N-k) and layer (N-2), and the corresponding weight coefficients, determined in the manner mentioned above, are α₀/(α₀+α_{N-k}+α_{N-2}), α_{N-k}/(α₀+α_{N-k}+α_{N-2}) and α_{N-2}/(α₀+α_{N-k}+α_{N-2}) respectively. Next, the weighted average (the value of the blended pixel) for the location P₁ can be computed as (a₁*α₀+c₁*α_{N-k}+e₁*α_{N-2})/(α₀+α_{N-k}+α_{N-2}), where a₁, c₁ and e₁ are the values of the correspondingly located pixels within the images A, C and E respectively. The weighted average for other locations within this image-overlapping area can also be obtained by the same manner as the location P₁.

The location P₂ lies in the image-overlapping area formed by overlapping the images A and F. That is, the overlapped image layers for this image-overlapping area are layer 0 and layer (N-1), and the corresponding weight coefficients are α₀/(α₀+α_{N-1}) and α_{N-1}/(α₀+α_{N-1}) respectively. Then, the weighted average for the location P₂ can be computed as (a₂*α₀+f₂*α_{N-1})/(α₀+α_{N-1}), where a₂ and f₂ are the values of the correspondingly located pixels within the images A and F respectively. Similarly, the location P₃ lies in the image-overlapping area formed by overlapping the images B and D. The overlapped image layers are layer 1 and layer (N-2), and the corresponding weight coefficients are α₁/(α₁+α_{N-2}) and α_{N-2}/(α₁+α_{N-2}) respectively. Then, the weighted average for the location P₃ can be computed as (b₃*α₁+d₃*α_{N-2})/(α₁+α_{N-2}), where b₃ and d₃ are the values of the correspondingly located pixels within the images B and D respectively.

Besides, FIG. 2 also shows a location P₄ that does not lie in any image-overlapping area. Thus, The pixel value a₄ at the location P₄ of the image A is used as the pixel value at the location P₄ of the blended image.

In one embodiment, the corresponding transparent coefficient of a lower image layer is larger (i.e. less transparent) than that of an upper one. For example, in FIG. 2, the transparent coefficients of the N image layers can be set as N/N, (N-1)/N . . . (N-k)/N . . . 2/N and 1/N from bottom to top.

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

What is claimed is:

1. A method for blending pixels of a plurality of overlapping layers of images in an image-overlapping area to generate a blended pixel in the image-overlapping area, each overlapping layer of image having a plurality of pixels and a corresponding transparent coefficient, the method comprising the steps of:
providing a lookup table, wherein the lookup table outputs a corresponding weight coefficient for each overlapping layer, and the corresponding weight coefficient is determined according to the transparent coefficients of the overlapping layers; and
blending the pixels of the overlapping layers of images in the image-overlapping area and thereby generating the blended pixel according to values of the pixels of the overlapping layers of images and the corresponding weight coefficients outputted by the lookup table.

2. The method of claim 1, wherein the corresponding weight coefficient for each overlapping layer is equal to a ratio of the transparent coefficient of the each overlapping layer to a sum of the transparent coefficients of the overlapping layers.

3. The method of claim 1, wherein the corresponding weight coefficient for each overlapping layer is a fraction with a denominator of 2ⁿ, wherein n is a positive integer.

4. The method of claim 1, wherein the corresponding transparent coefficient for each overlapping layer of image is predetermined.

5. The method of claim 1, wherein the corresponding transparent coefficient of a lower one of the overlapping layers is larger than that of an upper one.

6. The method of claim 1, wherein at least one of the overlapping layers of images is the layer of a video image.

7. The method of claim 1, wherein at least one of the overlapping layers of images is the layer of a still image.

8. The method of claim 1, wherein at least one of the overlapping layers of images is the layer of an OSD (on-screen display) image.

9. A method for blending pixels of a plurality of layers of images into a blended image, each layer of image having a plurality of pixels and a corresponding transparent coefficient, wherein at least one image-overlapping area is formed by overlapping at least two of the layers of images, the method comprising the steps of:
providing a lookup table for storing a plurality of weight coefficient sets, each weight coefficient set corresponding to a subset of the layers of images and the transparent coefficients of the layers of images within the subset;
selecting one of the weight coefficient sets in the lookup table according to the overlapped layers in the image-overlapping area; and
blending a correspondingly located pixel of each overlapped layer of image in the image-overlapping area and thereby generating a blended pixel of the blended image according to values of the correspondingly located pixels of the overlapped layers in the image-overlapping area and the selected weight coefficient set.

10. The method of claim 9, wherein the corresponding transparent coefficient of a lower one of the layers of images is larger than that of an upper one.

11. The method of claim 9, wherein the corresponding transparent coefficient for each overlapped layer in the image-overlapping area is predetermined.

12. The method of claim 9, wherein each weight coefficient within the selected weight coefficient set is a fraction with a denominator of ₂′, wherein n is a positive integer.

13. The method of claim 12, wherein at least one of the layers of images is the layer of a video image.

14. The method of claim 12, wherein at least one of the layers of images is the layer of an OSD (on-screen display) image.
